(19) United States
(12) Patent Application Publication
(10) Pub. No.: US 2004/0093382 A1
(43) Pub. Date: May 13, 2004

(54) Method of transmitting an electronic mail message

(76) Inventor: Suhas Sudhakar Kulkarni, Thane (IN)

Correspondence Address: HEWLETT-PACKARD COMPANY, Intellectual Property Administration, P.O. Box 272400, Fort Collins, CO, 80527-2400, US

(21) Appl. No.: 10/293,058

(22) Filed: Nov. 13, 2002

(51) Int. Cl. G06F 15/16

(52) U.S. Cl. 709/206; 709/238

(57) ABSTRACT

A method of transmitting an electronic mail message addressed to a group of recipients using a group alias by temporarily excluding a member from the group alias without modifying the group alias is provided. To perform the present invention, the standard electronic mail message format further includes a field to receive the address of a member for temporarily excluding him from receiving a current message. The group alias is first resolved into a list of individual addresses from which the address to be excluded is located and temporarily removed before transmitting the message to the remaining recipients.

### BACKGROUND OF THE INVENTION

1. Field of the Invention.

The present invention relates to electronic mail systems. More particularly, it relates to a method of transmitting an electronic message addressed to a group alias and temporarily excluding an address from the group alias.

2. Description of Background Information.

Electronic mail systems provide a speedy and paperless way of communication between two or more computer users. Electronic mail (hereinafter “e-mail”) allows a sender to send a message to a group of people by simply specifying the e-mail addresses of all group members or by specifying only a group alias. A group alias is an abbreviation that can be resolved into a list of e-mail addresses corresponding to a group of recipients. Such a list is also known as a distribution or mailing list. Group aliases are particularly useful when members of the group are relatively fixed, such as a department in a corporation, subscribers of a list server service and a hobby group. Instead of typing in all addresses each time an e-mail message is composed for sending to a group of recipients, the sender simply types a group alias.

In some real-life situations, it may be necessary to exclude individual addresses from a group alias while addressing a message to an entire group. Such situations include (1) soliciting confidential feedback from a department about an individual's performance, (2) arranging a surprise birthday party for an individual within the group, (3) sending reminders on a group activity where some individuals have been excused from attending and (4) distributing topical information to selected members of a group.

For these reasons, amongst others, e-mail users need an improved method and tool for temporarily excluding an address from an e-mail message addressed to a group alias.

### SUMMARY OF THE INVENTION

The present invention provides a method of transmitting an e-mail message addressed to a group of recipients using a group alias, where at least one group member is temporarily excluded from receiving the current message without modifying the group alias or typing the recipient addresses individually. According to the present invention, the e-mail message is composed in a manner known in the art, including specifying at least a group alias for addressing the group of recipients. The at least one group member is temporarily excluded from receiving the current message by specifying his address in an “Exclude” field (“Ex”). The message is first transmitted from a first mail server to a second mail server for resolving the group alias into a list of individual addresses. The excluded member is then located within the list of individual addresses and temporarily removed from the list before transmitting the message to the remaining addresses.

In order to detect typographical errors and to prevent delivery to the excluded member, the address of the excluded member may be validated before the message is transmitted to the recipients. The address of the excluded member is sent to its domain where the address is validated for its existence. If the address is invalid or does not exist, the sender or mail server of the sender is notified and the transmission of the message is withheld.

In accordance with the present invention, the message header of an email message further comprises an “Ex” field where a sender types the address of a member for temporarily excluding him from receiving the current message without modifying the group alias.

The present invention also includes a computer-readable or storage medium embodying program instructions at the electronic mail servers or computing systems of e-mail users for performing the invention as described in the following paragraphs.

### BRIEF DESCRIPTION OF THE DRAWINGS

The present invention is described with reference to accompanying drawings, in which:

FIG. 1 illustrates a conventional e-mail system.

FIG. 2 is a screen shot of a prior art message format when a user composes a message.

FIG. 3 illustrates a flow sequence of the transmission of an e-mail message in accordance with the present invention.

FIG. 4A is a screen shot of a message format in accordance with the present invention when a user composes a message.

FIG. 4B is a screen shot of a message format in accordance with the present invention when a recipient views a message.

### DETAILED DESCRIPTION

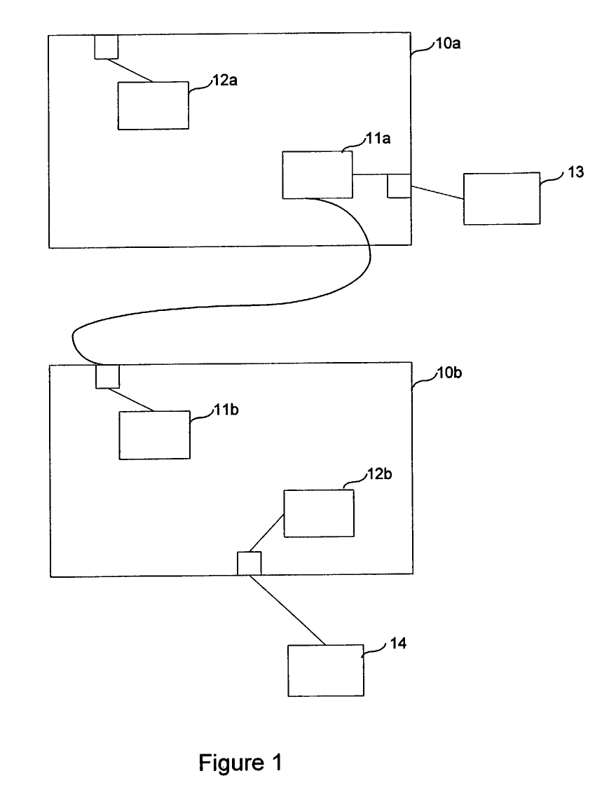

The general state of the art pertinent to the present invention will be briefly described in the following paragraphs. Reference is now made to FIG. 1, which illustrates a conventional e-mail system. Generally, an electronic mail server contains two server processes: a Simple Mail Transfer Protocol (SMTP) server, which handles outgoing mails, and a Post Office Protocol (POP3), which handles incoming mails. In the current description, a sender is arbitrarily located at “outhost.com” domain 10a while a recipient is located at “inhost.com” domain 10b.

The sender at “outhost.com” domain 10a may use a standalone e-mail client 13 like Microsoft® Outlook® or a web-based client 13 like Yahoo?® to access his electronic mailbox. When the user composes a message, he specifies the e-mail addresses of his recipients and a message body 25. Thereafter, he initiates a “sendmessage” action. The sender's e-mail client 13 connects to the SMTP server 11a of “outhost.com” and transmits the message, including the message header and the message body 25, to the SMTP server 11a of “outhost.com”. Thereafter, the “outhost.com” SMTP server 11a parses the recipient addresses into its e-mail identifier and domain name. If the domain of the recipient is also at “outhost.com,” the SMTP server 11a transmits the message to the POP3 server 12a of “outhost.com”. If the recipient is at a different domain, for example, “inhost.com” 10b, the SMTP server 11a of “outhost.com” communicates with a Domain Name Server (DNS) to obtain the Internet Protocol (IP) address of the recipient domain. Upon receipt of the IP address, the “outhost.com” SMTP server 11a establishes contact with the “inhost.com” SMTP server 11b and transmits the message to the recipient “inhost.com” SMTP server 11b, which accordingly transmits the message to the POP3 server 12b of “inhost.com.” The message is transmitted to the recipient's mailbox 14 for his retrieval.

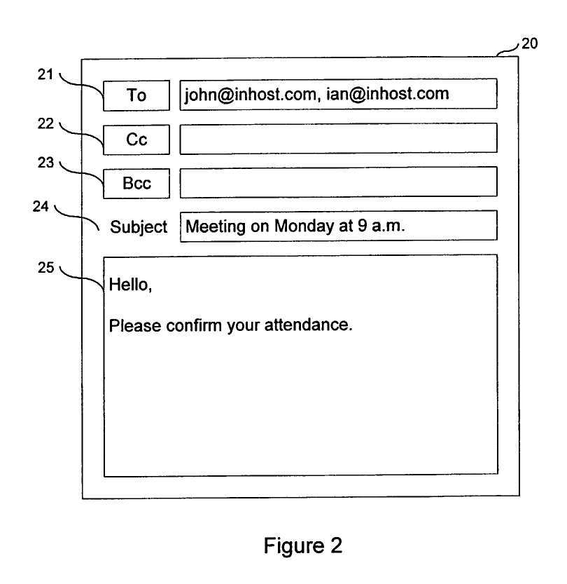

E-mail messages are constructed using a standard format according to the Standard for the Format of APRA Internet Text Messages specification (RFC822). According to this standard, an e-mail message comprises a message header and a message body 25, where the latter contains text and attachments. The standard format as often presented to users is illustrated in FIG. 2. The message header includes at least the following:

Subject:<subject line>

To:<main recipients>

Cc:<copy recipients>

Bcc:<bcc recipients>

. . .

As per the current art, the “To” field 21 contains e-mail addresses of the main recipients. The “Cc” field 22 contains the e-mail addresses of the copy (secondary) recipients. The “Subject” field 24 often contains a short phrase or summary indicative of the message contents. However, this field is user-defined and does not have to comply with a standard format. The message header also contains a “Bce” field 23; recipients specified in the “Bcc” field 23 are hidden from other recipients, viz. main and copy recipients.

A group alias allows a sender to send a message to a group of recipients simply by specifying the group alias. The group alias has to be first created by specifying a list of individual e-mail addresses of members of the group and assigning a name (group alias) to the list. Thereafter, the group alias may be utilized when addressing a message to the members of this group. A group alias may also include other group aliases or a combination of individual e-mail addresses and group aliases. In the current state of art (as described in the above paragraphs), when a sender wishes to exclude one or more members of a group alias, he has to retype the list of individual addresses without those of the excluded members.

The present invention provides a tool for temporarily and selectively excluding members from a group alias without modifying the group alias. According to the present invention, the message header of an e-mail message includes at least:

Subject:<subject list>

To:<main recipients>

Cc:<copy recipients>

Bcc:<bcc recipients>

Ex:<exclude list>

. . .

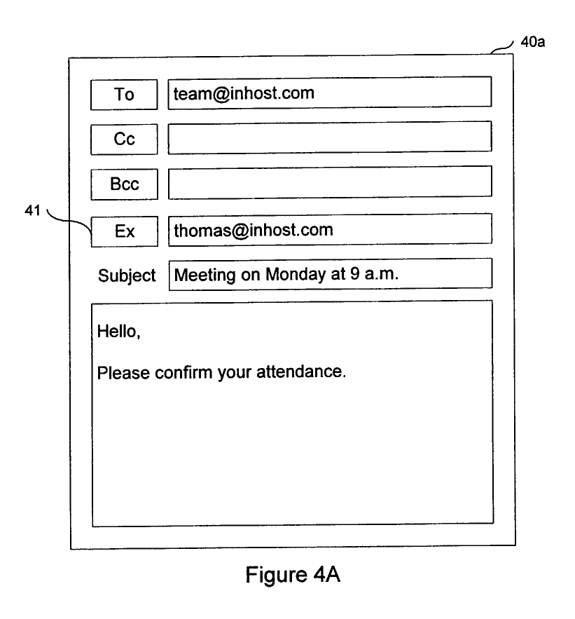

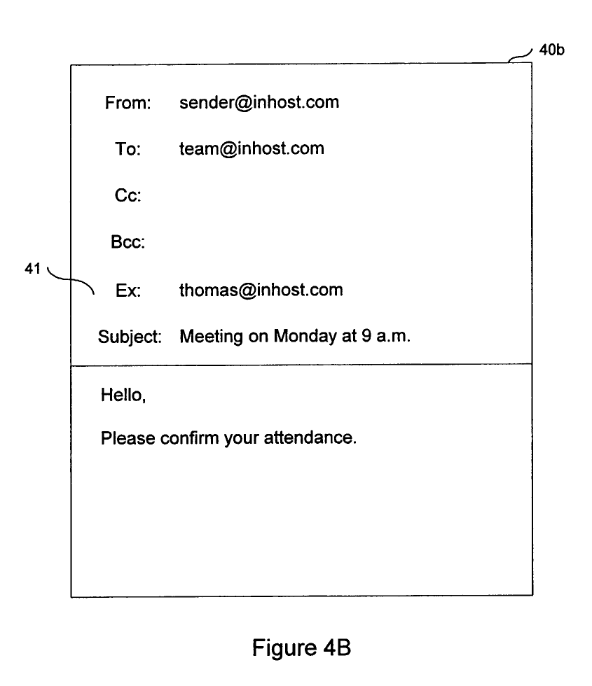

A typical message format 40a according to the present invention having the “Ex” field 41 in a message composition mode is illustrated in FIG. 4A. The “Ex” field 41 contains the addresses to exclude (hereinafter “exclude list”) from group alias and recipient lists specified in the “To” 21, “Cc” 22 and “Bcc” 23 fields. The “Ex” field 41 is typically used when one or more group aliases have been specified as recipients and the sender needs to temporary exclude one or more recipients from receiving the current message. To exclude these recipients from receiving the current message, the sender specifies one or more e-mail addresses or group aliases or both in the “Ex” field 41.

The following paragraphs describe how an e-mail message containing a group alias and an excluded address is handled after a sender initiates an action to send the message. As an illustration, a sender at <sender@outhost.com>addresses his message to a group whose group alias is known as <team@inhost.com>. Members of the group alias include, amongst others, <john@inhost.com>, <ian@inhost.com>, and <thomas@inhost.com>. The exclude list comprises <thomas@inhost.com>.

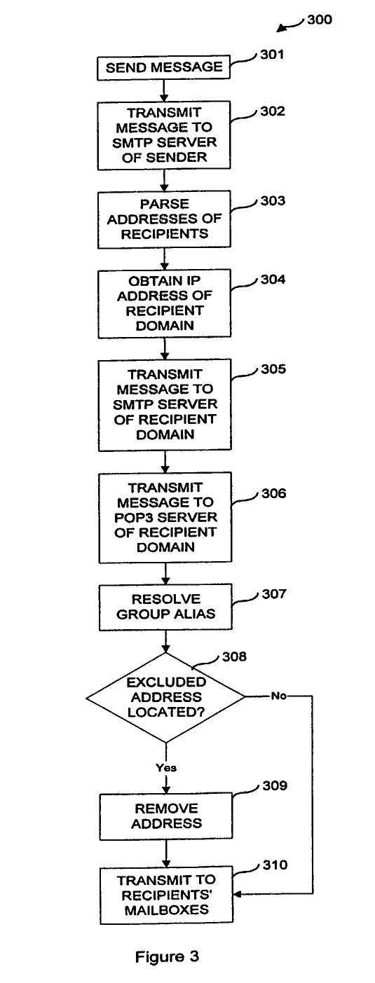

Reference is now made to a flow sequence 300 in FIG. 3. The sequence 300 starts in a SEND MESSAGE step 301 when a sender initiates an action from his e-mail client to send a message. The e-mail client establishes contact with the SMTP server 11a of “outhost.com” and transmits the e-mail message, including the recipient address, viz. “team@inhost.com” in a TRANSMIT MESSAGE TO SMTP SERVER OF SENDER step 302. According to the present invention, the e-mail client also transmits the exclude list, viz. <thomas@inhost.com>to the SMTP server 11a. The sequence 300 then proceeds to a PARSE ADDRESSES OF RECIPIENTS step 303, where the SMTP server 11a parses the recipient addresses into two parts, namely the e-mail identifier and domain name.

The sequence 300 then proceeds to an OBTAIN IP ADDRESS OF RECIPIENT DOMAIN step 304. The SMTP server 11a of “outhost.com” establishes contact with the Domain Name Server (DNS) to obtain the Internet Protocol (IP) address for “inhost.com” 10b. When the IP address is obtained, the sequence 300 proceeds to TRANSMIT MESSAGE TO SMTP SERVER OF RECIPIENT DOMAIN step 305, where the SMTP server 11a of “outhost.com” establishes contact with the SMTP server 11b of “inhost.com”. The SMTP server 11a of “outhost.com” sends the message, including the message header and body 24, to the SMTP server 11b of “inhost.com”. According to the present invention, the exclude list is also transmitted to the SMTP server 11

b of “inhost.com”. The sequence 300 then proceeds to a TRANSMIT MESSAGE TO POP3 SERVER OF RECIPIENT DOMAIN step 306 when the SMTP server 11b of “inhost.com” recognizes that the group alias belongs to “inhost.com” domain 10b. The POP3 server 12b resolves the group alias into individual e-mail addresses in a RESOLVE GROUP ALIAS step 307. The POP3 server 12b contains a mail alias file containing member lists for each group alias. Using the mail alias file, the POP3 server 12b resolves the group alias into corresponding individual addresses. The POP3 server 12b may need to perform the resolution repeatedly or recursively since the group alias may contain several members or several group aliases, or both. When this is completed, the POP3 server 12b has a list of all e-mail addresses where the message should be sent. At this point, the list of individual addresses includes both the exclude list and recipient list. According to the present invention, the POP3 server 12b checks the addresses of the exclude list against the list of individual recipient addresses. If any address in the exclude list is located from the recipient list, the sequence 300 proceeds through an EXCLUDED ADDRESS LOCATED? decision step 308 to a REMOVE ADDRESS step 309, where the address in the exclude list is temporarily removed from the recipient address list. The recipient list now comprises only the addresses of the remaining recipients. The sequence 300 then proceeds to a TRANSMIT TO RECIPIENTS' MAILBOXES step 310, where the message is directed into the respective mailboxes of the remaining recipients. The respective remaining recipients can now access their mailboxes through their e-mail clients as known in the art. If the addresses in the exclude list do not match any of the individual recipient addresses, the message is put into the mailboxes 14 of all members of the group alias in a TRANSMIT TO RECIPIENTS' MAILBOXES step 310.

Reference is now made to FIG. 4B where a typical message format of a received message 40b according to the present invention is illustrated. As known in the art, the sender's address is displayed. Addresses of other recipients may also be displayed. According to the present invention, the excluded members or addresses of the current message are also displayed to the recipients.

The earlier paragraphs describe a situation where the recipients are located in a same domain. If the group alias comprises recipients from different domains, the complete exclude list will be sent to the SMTP servers of all recipient domains in TRANSMIT MESSAGE TO SMTP SERVER OF RECIPIENT DOMAIN step 305. The SMTP servers of the various recipient domains then forward the exclude list to the respective POP3 servers in MESSAGE TO POP3 SERVER OF RECIPIENT DOMAIN step 306. The group alias is resolved in all recipient domains in the RESOLVE GROUP ALIAS step 307. If an address in the exclude list matches a member in a particular domain, this member is removed from the recipient list so that the POP3 server 12b does not transmit the message into this member's mailbox.

Sometimes, a sender may mistype the addresses in the exclude list. Unknown to the sender, the message is delivered to the intended excluded addressees and causes inconvenience and embarrassment to the sender. Hence, a checking tool may be needed to validate the addresses of the exclude list. In an implementation of a checking tool, the “outhost.com” SMTP server 11a sends the exclude list to all destination domains specified in the exclude list to validate the addresses. This validation step may be carried out when the sender initiates a send-message action. With this checking tool, the message is not immediately transmitted when the sender initiates the send-message action. Instead, a validation check is performed before the message is actually transmitted to the recipient domains. The message will be transmitted to the respective recipient domains when all addresses in the exclude list are validated.

More specifically, the “outhost.com” SMTP server 11a first sends the exclude list, viz. <thomas@inhost.com>to the “inhost.com” domain 10b for validation. Upon receipt of the exclude list from the “outhost.com” server, the “inhost.com” SMTP server 11b checks with its POP3 server 12b to validate the addresses in the exclude list. If the excluded addresses exist in the domain, the “inhost.com” SMTP server 11b sends a notification to the “outhost.com” SMTP server 11a to acknowledge that the excluded addresses have been validated. When the “outhost.com” SMTP server 11a is notified that all excluded addresses are valid, the message is then transmitted to “inhost.com” domain 10b for resolving the group alias into individual addresses and removing the excluded addresses before transmitting to the intended recipients. However, if the excluded address does not exist in a destination domain, the “inhost.com” domain sends an error notification to the “outhost.com” SMTP server 11a. The sender is then prompted to modify the excluded address before validating the modified address or sending the message.

What is claimed is:

1. A method of transmitting an electronic mail message comprising:
addressing a plurality of recipients using a group alias;
specifying a first address for excluding from the plurality of recipients;
resolving the group alias into a plurality of addresses corresponding to the plurality of recipients; and
transmitting the message to a remaining plurality of addresses comprising the plurality of addresses excluding the first address, without modifying the group alias.

2. The method recited in claim 1 further comprising:
locating the first address among the plurality of addresses; and
temporarily removing the first address therefrom.

3. The method recited in claim 2 further comprising:
transmitting the first address from a first mail server to a second mail server for validating the first address; and
notifying the first mail server of an outcome of the validation.

4. The method recited in claim 3 further comprising:
determining whether or not to transmit the message to the remaining plurality of addresses based on the outcome of the validation.

5. A computer-readable medium embodying program instructions, the program instructions configured for receiving a first address and a group alias, the group alias is transmitted from a first mail server to a second mail server for resolving the group alias into a plurality of addresses, and transmitting the message to a remaining plurality of addresses comprising the plurality of addresses excluding the first address, without modifying the group alias.

6. The computer-related medium recited in claim 5, wherein the first address is located from the plurality of addresses and temporarily removed therefrom.

7. The computer-related medium recited in claim 6, wherein the program instructions are further configured for validating the first address before transmitting the message to the remaining plurality of addresses.

8. The computer-related medium recited in claim 7, wherein the program instructions are further configured to determine whether or not to transmit the message to the remaining plurality of addresses.

9. The computer-related medium recited in claim 8, wherein the first mail server is also the second mail server.

10. A method of temporarily excluding a first address from a group alias in an electronic mail message comprising:
resolving the group alias into a plurality of addresses;
excluding the first address from the plurality of addresses; and
transmitting the message to a remaining plurality of addresses comprising the plurality of addresses excluding the first address, without modifying the group alias.

11. The method recited in claim 10 further comprising:
locating the first address among the plurality of addresses; and
temporarily removing the first address therefrom.

12. The method recited in claim 11 further comprising:
transmitting the first address from a first mail server to a second mail server for validating the first address; and
notifying the first mail server of an outcome of the validation.

13. The method recited in claim 12 further comprising:
determining whether or not to transmit the message to the remaining plurality of addresses based on the outcome of the validation.

14. An electronic mail message format having a first field for receiving a group alias and for addressing a message to a plurality of recipients, wherein the message format comprises:
a second field for receiving at least a first address for temporarily excluding from the group alias without modifying the group alias, wherein after the group alias is resolved into a plurality of addresses corresponding to the plurality of recipients, the message is transmitted to a remaining plurality of addresses comprising the plurality of addresses excluding the first address.

15. The electronic mail message format recited in claim 14, wherein the first address is located from the plurality of addresses and temporarily removed therefrom.

16. The electronic mail message format recited in claim 15, wherein the first address is transmitted to its destination domain for validation before the message is transmitted to the remaining plurality of addresses.

17. The electronic mail message format recited in claim 16, wherein the first address is displayed as an excluded address in the message received by the remaining plurality of addresses.
